(19) United States
(12) Patent Application Publication
(10) Pub. No.: US 2025/0242515 A1
(43) Pub. Date: Jul. 31, 2025

(54) CHAINSAW WITH IMPROVED BATTERY FEATURES

(71) Applicant: Milwaukee Electric Tool Corporation, Brookfield, WI (US)

(72) Inventors: Helton Vandenbush, Brookfield, WI (US); Gordy Russell, Brookfield, WI (US)

(21) Appl. No.: 19/037,929

(22) Filed: Jan. 27, 2025

Related U.S. Application Data
(60) Provisional application No. 63/625,583, filed on Jan. 26, 2024.
(60) Provisional application No. 63/565,214, filed on Mar. 14, 2024.
(60) Provisional application No. 63/736,821, filed on Dec. 20, 2024.

(51) Int. Cl. B27B 17/02; B27B 17/00; B27B 17/08; B27B 17/12; H01M 50/247; H01M 50/256

(52) U.S. Cl. CPC B27B 17/02; B27B 17/0008; B27B 17/083; B27B 17/12; H01M 50/247; H01M 50/256; H01M 2220/30

(57) ABSTRACT

Chainsaws are provided. A chainsaw includes a guide bar include an outer track. The chainsaw also includes a chain movably coupled to the outer track. The chainsaw further includes a housing defining an interior, wherein at least a portion of the guide bar and at least a portion of the motive device are disposed in the interior. The housing includes an upper surface and a lower surface spaced apart along a vertical axis, a first side surface and a second side surface spaced apart along a lateral axis, and a front surface and a rear surface spaced apart along a longitudinal axis. The chainsaw still further includes a motive device mounted within the interior and operable to move the chain relative to the guide bar.

### CROSS-REFERENCE TO RELATED APPLICATIONS

The present application claims priority to 63/625,583 filed on Jan. 26, 2024; 63/565,214 filed on Mar. 14, 2024; and 63/736,821 filed on Dec. 20, 2024, the disclosures of which are incorporated by reference herein in its entirety.

### FIELD

The present disclosure relates generally to outdoor power tools, such as chainsaws.

### BACKGROUND

Outdoor power tools such as chainsaws utilize a moving chain with teeth to cut into material, such as wood. The teeth are driven along an outer path of a guide bar in a continuous manner by a driving element. The driving element is controlled by a trigger located on a handle of the chainsaw. As the operator engages the trigger, the speed of the driving element changes, resulting in operation of the chainsaw.

Recently, battery powered outdoor power tools have increased in popularity. However, battery life is a frequent issue. Additionally, battery position can be a concern as it relates to balance and ergonomics of the chainsaw.

Accordingly, improvements which address the above-described issues are desired in the art and would be advantageous.

### BRIEF DESCRIPTION

Aspects and advantages of the present disclosure will be set forth in part in the following description, or may be obvious from the description, or may be learned through practice of the technology.

In accordance with one embodiment, a chainsaw is provided. The chainsaw includes a guide bar; a chain movably coupled to the outer track; a motive device operable to move the chain relative to the guide bar; a housing; and a battery interface. The housing may define an interior. At least a portion of the guide bar and at least a portion of the motive device are disposed in the interior. The housing includes an upper surface and a lower surface spaced apart along a vertical axis, a first side surface and a second side surface spaced apart along a lateral axis, and a front surface and a rear surface spaced apart along a longitudinal axis. The battery interface is disposed on the housing at the upper surface.

In accordance with another embodiment, a chainsaw is provided. The chainsaw includes a guide bar, a chain, a housing, and a motive device. The guide bar includes an outer track. The chain is movably coupled to the outer track. The housing defines an interior. At least a portion of the guide bar and at least a portion of the motive device are disposed in the interior. The housing includes an upper surface and a lower surface spaced apart along a vertical axis, a first side surface and a second side surface spaced apart along a lateral axis, and a front surface and a rear surface spaced apart along a longitudinal axis. The housing defines an air intake upstream from the interior and an air exhaust downstream from the interior. The air exhaust is defined below the air intake. The motive device is mounted within the interior in fluid communication between the air intake and the air exhaust. The motive device is operable to move the chain relative to the guide bar.

In accordance with yet another embodiment, a chainsaw is provided. The chainsaw includes a guide bar, a chain, a housing, a motive device, and a lubrication system. The guide bar includes an outer track. The chain is movably coupled to the outer track. The housing defines an interior. At least a portion of the guide bar and at least a portion of the motive device are disposed in the interior. The housing includes an upper surface and a lower surface spaced apart along a vertical axis, a first side surface and a second side surface spaced apart along a lateral axis, and a front surface and a rear surface spaced apart along a longitudinal axis. The motive device is mounted within the interior and operable to move the chain relative to the guide bar. The lubrication system provides lubricant to the chain and includes a reservoir housing the lubricant, a pump in mechanical communication with the motive device to be driven by the same, and an output configured to supply the lubricant to the guide bar and the chain.

These and other features, aspects and advantages of the present disclosure will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present application, including the best mode of making and using the present systems and methods, directed to one of ordinary skill in the art, is set forth in the specification, which makes reference to the appended figures, in which:

FIG. 1 is a perspective view of a chainsaw in accordance with embodiments of the present disclosure;

FIG. 2 is another perspective view of a portion of a chainsaw in accordance with embodiments of the present disclosure;

FIG. 3 is a top view of a chainsaw in accordance with embodiments of the present disclosure;

FIG. 4 is a bottom view of a chainsaw in accordance with embodiments of the present disclosure;

FIG. 5 is a rear view of a chainsaw in accordance with embodiments of the present disclosure;

FIG. 6 is a front view of a chainsaw in accordance with embodiments of the present disclosure;

FIG. 7 is a side view of a chainsaw in accordance with embodiments of the present disclosure;

FIG. 8 is an opposite side view of a chainsaw in accordance with embodiments of the present disclosure;

FIG. 9 is the side view of FIG. 9 with a portion of a housing removed such that internal components of the chainsaw are visible in accordance with embodiments of the present disclosure;

FIG. 10 is a bottom view of a chainsaw with a housing removed such that internal components of the chainsaw are visible in accordance with embodiments of the present disclosure;

FIG. 11 is a rear perspective view of a chainsaw in accordance with embodiments of the present disclosure;

FIG. 12 is the rear perspective view of FIG. 11 with a battery removed in accordance with embodiments of the present disclosure;

FIG. 13 is a perspective view of a battery for a chainsaw in accordance with embodiments of the present disclosure;

FIG. 14 is another perspective view of a battery for a chainsaw in accordance with embodiments of the present disclosure;

FIG. 15 is a perspective view of a chainsaw with a side portion of the housing removed such that internal components of the chainsaw are visible in accordance with embodiments of the present disclosure;

FIG. 16 is a magnified perspective view of a chainsaw with a housing removed such that internal components of the chainsaw are visible in accordance with embodiments of the present disclosure;

FIG. 17 is a perspective view of a chainsaw in accordance with embodiments of the present disclosure;

FIG. 18 is a magnified perspective view of a chainsaw with a portion of a housing removed such that internal components of the chainsaw are visible in accordance with embodiments of the present disclosure;

FIG. 19 is another magnified perspective view of a chainsaw with a portion of a housing removed and certain components made transparent such that internal components of the chainsaw are visible in accordance with embodiments of the present disclosure;

FIG. 20 is a perspective view of a lubricant pump in accordance with embodiments of the present disclosure;

FIG. 21A is a side view of the lubricant pump of FIG. 20 at a high flow setting, with the housing of the pump shown in translucence;

FIG. 21B is a side view of the lubricant pump of FIG. 20 at a lowest flow setting, with the housing of the pump shown in translucence; and

FIG. 22 is a perspective view of a lubricant pump in accordance with embodiments of the present disclosure.

### DETAILED DESCRIPTION

Reference now will be made in detail to embodiments of the present disclosure, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the disclosure.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive- or and not to an exclusive- or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, the present disclosure is directed to chainsaws which address one or more of the above-identified issues. More specifically, chainsaws in accordance with the present disclosure may advantageously provide improved battery life, while also having improved ergonomics which facilitate more efficient, comfortable use.

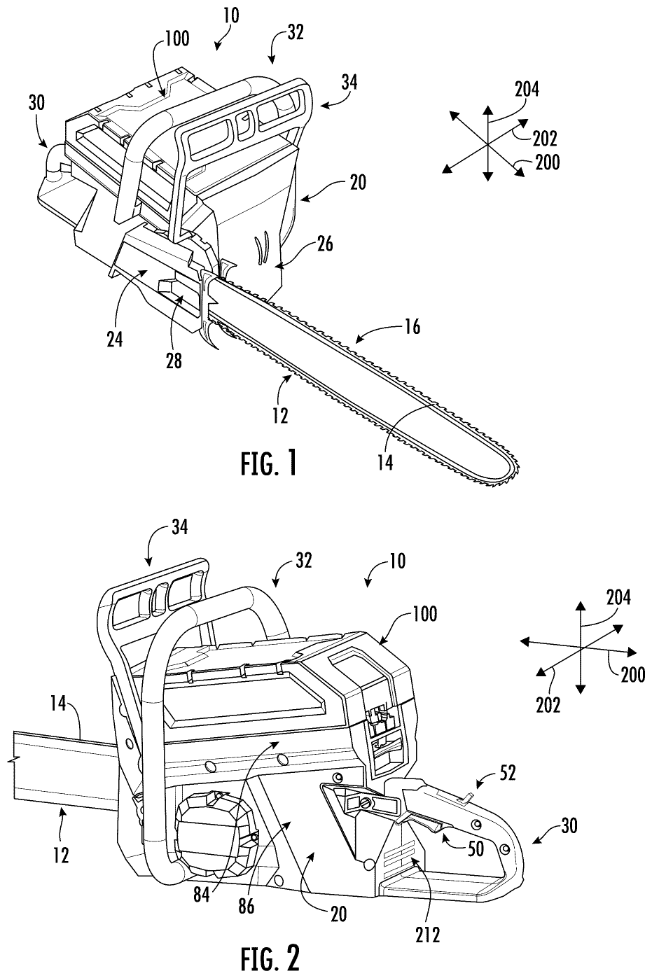

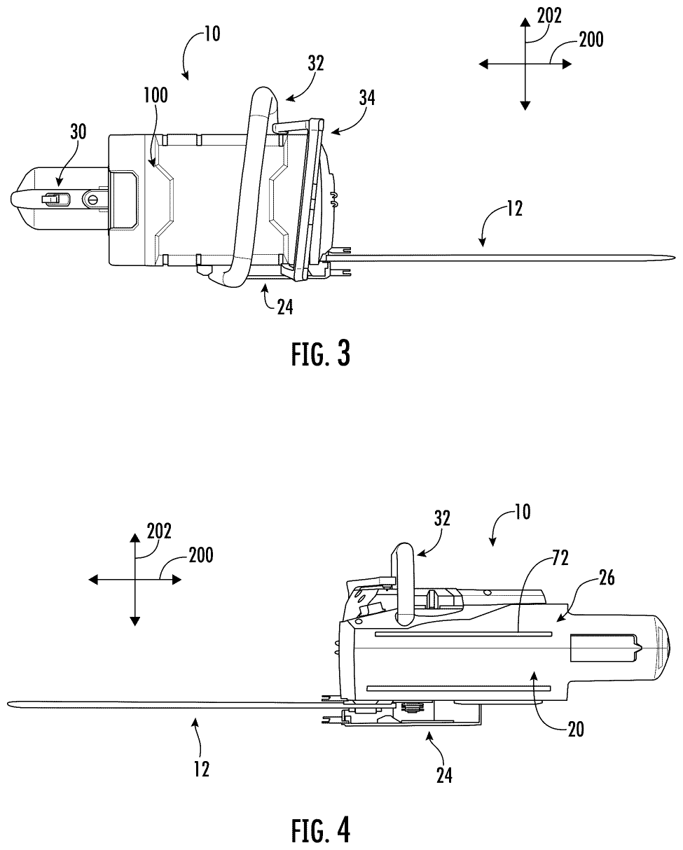

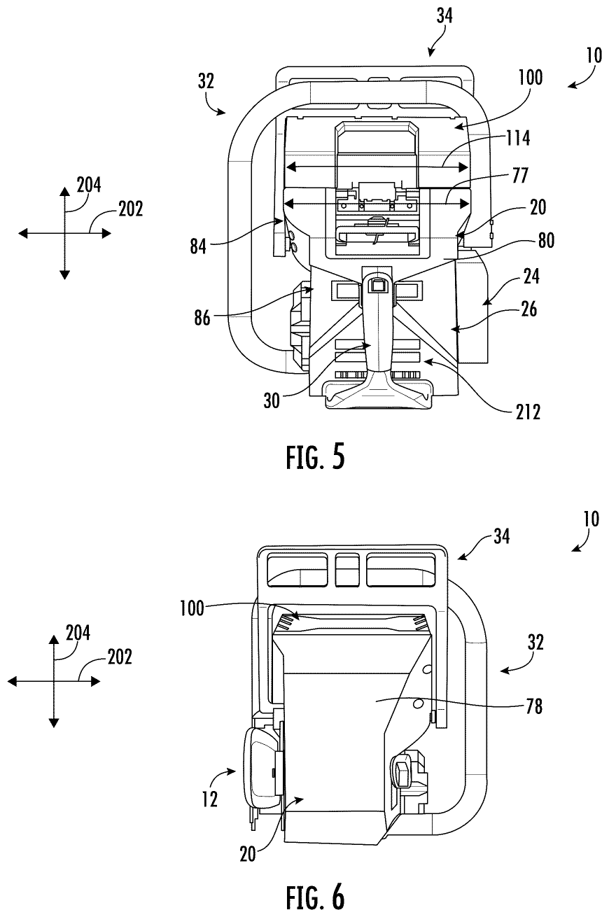

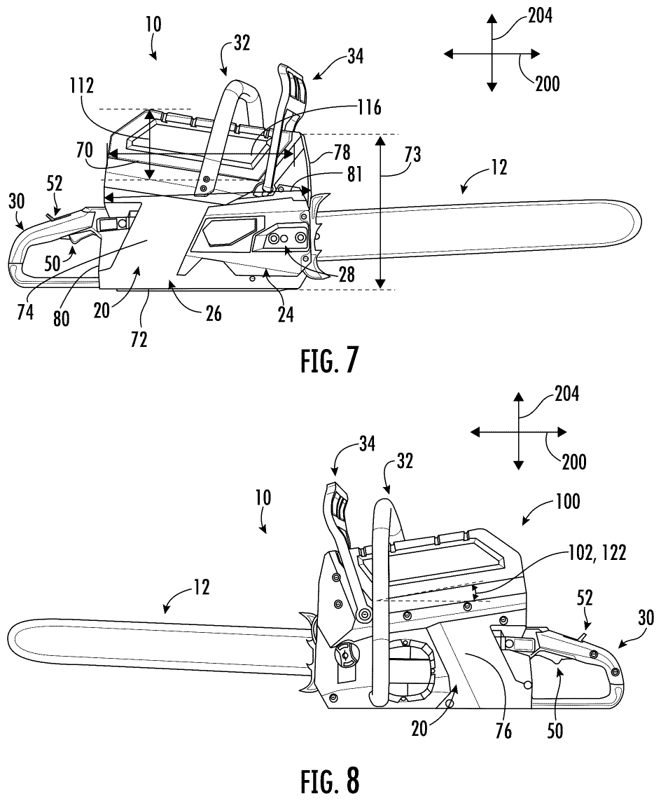

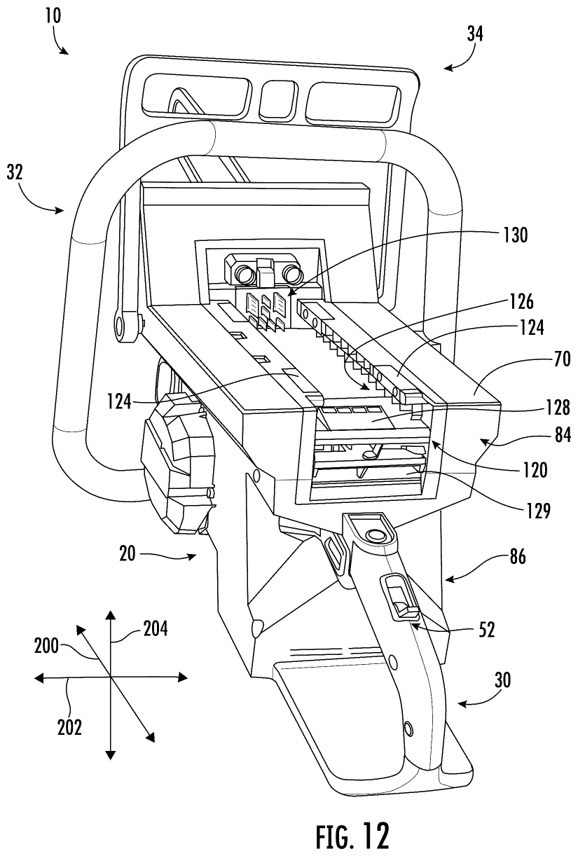

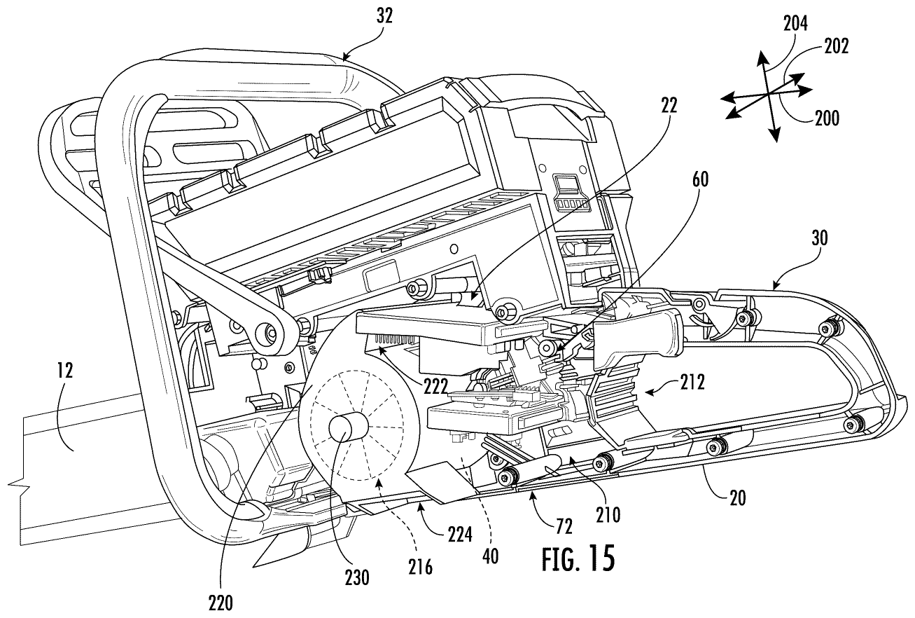

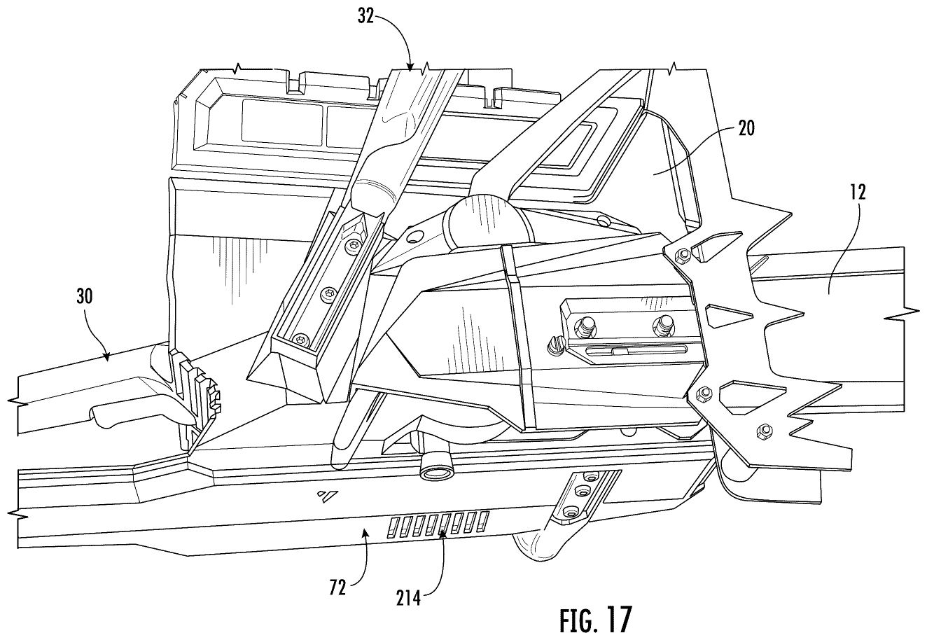

Referring now to FIGS. 1 through 12, as well as FIGS. 15 and 17, chainsaws 10 in accordance with embodiments of the present disclosure are provided. A chainsaw 10 may include a guide bar 12. Guide bar 12 may include an outer track 14. Chainsaw 10 may further include a chain 16 which is movably coupled to the guide bar 12, such as to the outer track 14 thereof. The chain 16 may include teeth which, when moved along the guide bar, cause the chain to cut into material, such as logs and branches. During operation of the chainsaw 10, the chain 16 may move along the outer track 14 to cause such cutting. Such movement may be caused by a motive device which drives the chain.

The chainsaw 10 may further include a housing 20 which defines an interior 22. The guide bar 12 can extend from the housing 20, such that at least a portion (e.g. an end portion 13) of the guide bar 12 extends into and is disposed in the interior 22. For example, housing 20 can include a guide bar cover portion 24 which is connected to a main housing portion 26. The guide bar 12 can extend between the main housing portion 26 and the guide bar cover portion 24 such that the end portion 13 is within the interior 22. A fastener assembly 28, which may for example include bolts, screws, and/or other suitable hardware, may affix the guide bar 12 to the housing 20, such as to the guide bar cover portion 24 and/or the main housing portion 26.

The chainsaw 10 may further include a handle, such as a primary handle 30. Additionally, in some embodiments, chainsaw 10 may include a secondary handle 32. Still further, in some embodiments, a brake 34 can be positioned along the chainsaw 10 at a location, for example, adjacent to the secondary handle 32. The brake 34 can provide safety braking which prevents the chainsaw 10 from kicking back onto the operator with the chain 16 moving. Upon occurrence of kickback, the brake 34 can be activated by hitting the operator's arm, thereby causing the chain 16 to abruptly slow down and/or stop. As shown, the brake 34 may be disposed within the interior 22 (e.g., below a battery interface 120).

The chainsaw 10 can further include a motive device 40, such as a gas powered engine or an electric motor (as shown). In some exemplary embodiments, at least a portion of the motive device 40, such as the entire motive device 40, is disposed in the interior 22, such as within the main housing portion 26. The motive device 40 may be operable to move the chain 16 relative to the guide bar 12. For example, the motive device 40 may drive a chain sprocket 42. The chain sprocket 42 can be engaged with the chain 16 such that rotation of the chain sprocket 42 causes the chain 16 to move relative to the guide bar 12. The motive device can be powered, for example, by a rechargeable energy source such as a battery 100 as shown.

The chainsaw 10 may further include an actuator 50. The actuator 50, such as a rotatable and/or depressible trigger, may be disposed proximate to (such as in some embodiments at least partially housed in) a handle, such as primary handle 30 or secondary handle 32. When depressed, the actuator can engage the motive device 40 to cause the chain 16 to move. As the actuator 50 is depressed further, a speed of the motive device 40 can increase from zero speed to a maximum speed. In this regard, the actuator 50 may variably affect the speed of the motive device 40 between a stopped speed, which occurs when the actuator 50 is not depressed, and a maximum speed, which occurs when the actuator 50 is fully depressed.

The chainsaw 10 may further include a lockout switch 52. The lockout switch 52, which may be rotatable and/or depressible, may be disposed proximate to (such as in some embodiments partially housed in) a handle, such as primary handle 30 or secondary handle 32. In some embodiments, lockout switch 52 may be disposed on the same handle as actuator 50, such as on an opposite side of the handle from actuator 50. Lockout switch 52 may be a safety mechanism which prevents operation of the chainsaw 10 unless the switch 52 is activated by an operator. Thus, if actuator 50 is actuated but lockout switch 52 is not actuated, the chainsaw 10 may not operate. If lockout switch 52 is actuated, then chainsaw 10 may operate upon actuation of the actuator 50.

In some embodiments, the chainsaw may further include a controller 60, such as a printed circuit board. The controller 60 may be operatively connected to, and may control or be controlled by, the actuator 50, lockout switch 52, battery 100, and/or motive device 40.

As shown, an orthogonal coordinate system may be defined for the chainsaw 10, and may include a longitudinal axis 200, a lateral axis 202, and a vertical axis 204, all of which may be mutually orthogonal to each other. As shown, guide bar 12 may extend from housing 20 along the longitudinal axis 200. Primary handle 30 may extend from the housing 20 along the longitudinal axis 200 in a direction opposite guide bar 12. Secondary handle 32 may extend above housing 20 along the vertical axis 204. Guide bar cover portion 24 may extend from main housing portion 26 along the lateral axis 202.

Housing 20, and in particular main housing portion 26 thereof, may include an upper surface 70 and a lower surface 72 spaced apart along the vertical axis 204. Housing 20, and in particular main housing portion 26 thereof, may further include a first side surface 74 and a second side surface 76 spaced apart along the lateral axis 202. Housing 20, and in particular main housing portion 26 thereof, may further include a front surface 78 and a rear surface 80 spaced apart along the longitudinal axis 200.

A height 73, width 77, and length 81 may be defined for the housing 20. Height 73 may be defined between upper surface 70 and a lower surface 72, such as along the vertical axis 204. Width 77 may be defined between first side surface 74 and second side surface 76, such as along the lateral axis 202. Length 81 may be defined between the front surface 78 and the rear surface 80, such as along the longitudinal axis 200. In some embodiments, a maximum length 81 of the housing 20 may be greater than a maximum width 77 of the housing 20. In some embodiments, a maximum length 81 of the housing 20 may be greater than a maximum height 73 of the housing 20.

Housing 20 may further include an upper housing portion 84 and a lower housing portion 86. Upper housing portion 84 may be above lower housing portion 86 along the vertical axis 204. In exemplary embodiments, a maximum width 77 of the upper housing portion 84 (e.g. the housing 20 at the upper housing portion 84) may be greater than a maximum width 77 of the lower housing portion 86 (e.g. the housing 20 at the lower housing portion 86).

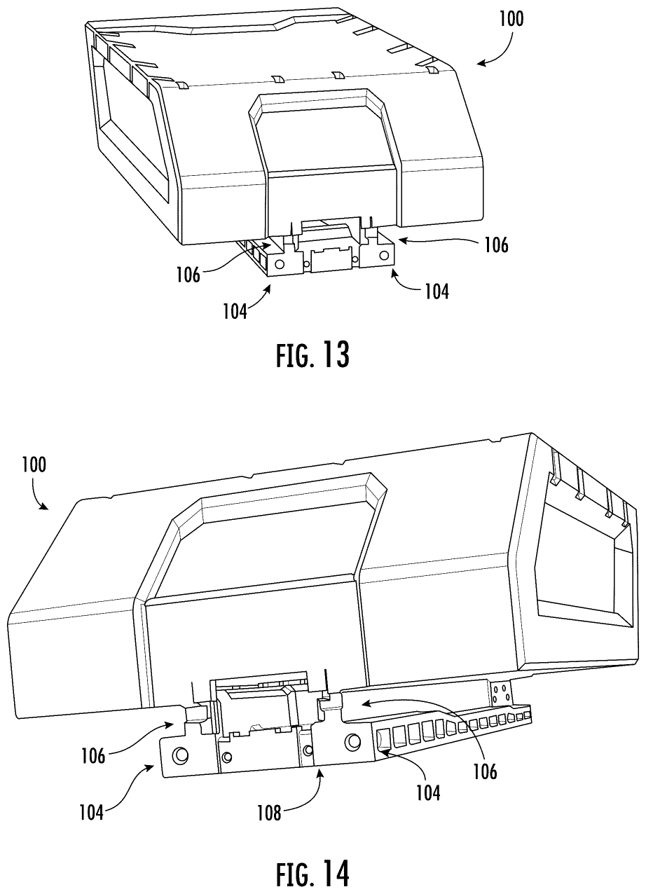

As discussed, and referring now additionally to FIGS. 13 and 14, chainsaw 10 may include a battery 100. Battery 100 may be operatively connected to, and may provide power to, the chainsaw 10, such as the motive device 40, when connected to the chainsaw 10. Battery 100 may be removably coupled to the chainsaw 10 to provide such power, such as removably coupled to the housing 20. For example, chainsaw 10 may further include a battery interface 120 which is disposed on the housing 20. Battery 100 may be removably coupled to the chainsaw 10 through the battery interface 120. When the battery 100 is coupled to the battery interface 120, power from the battery 100 may be provided through the battery interface 120 to the motive device 40.

Referring now specifically to FIGS. 11 through 14, battery interface 120 may be disposed on the upper surface 70 of the housing 20. The upper surface 70, and thus the battery interface 120, may be disposed at an angle 122 relative to the longitudinal axis 200, as shown. The angle 122 may be a downward angle from the rear surface 80 towards the front surface 78 along the longitudinal axis 200. In exemplary embodiments, the angle 122 may be between 2 degrees and 25 degrees, such as between 12 degrees and 20 degrees, such as between 14 degrees and 18 degrees. In optional embodiments, the angle 122 is about 16 degrees. In alternative embodiments, the angle 122 is about 4 degrees.

Battery interface 120 may include one or more rails 124 which define one or more channels 126. Battery interface 120 may further include a latch 128. Battery 100 may include one or more rails 104 which define one or more channels 106. Battery 100 may further include a latch interface 108. The rails 124 and channels 126 may extend along the longitudinal axis 200. Battery 100 may be coupled to housing 20 by sliding the battery 100 along the battery interface 120, such as along the longitudinal axis 200. The rails 124 may slide into the channels 106, and the rails 104 may slide into the channels 126, during such coupling movement. When the battery 100 is fully inserted into the battery interface 120, the latch 128 (which may be spring-biased) may lock into place in the latch interface 108 to removably lock the battery 100 into the battery interface 120 and onto the housing 20. To remove the battery 100 from the battery interface 120, a user may depress the latch 128 (such as via depressing a release 129) and slide the battery away from the housing 20 along the longitudinal axis 200. The latch 128 may be disposed on the upper surface 70 as shown and/or rear surface 80.

Battery interface 120 may further include electrical contacts 130 which interface with electrical contacts of the battery 100 when the battery is fully inserted into the battery interface 120, thus facilitating operative connection of the battery 100 to the motive device 40.

The battery 100 may be disposed on the upper surface 70, as shown. Thus, the battery 100 may be disposed on, and above along the vertical axis 204, the upper housing portion 84. In exemplary embodiments, the battery 100 may be disposed at an angle 102 relative to the longitudinal axis 200, as shown. The angle 102 may be a downward angle from the rear surface 80 towards the front surface 78 along the longitudinal axis 200. In exemplary embodiments, the angle 102 may be between 2 degrees and 25 degrees, such as between 12 degrees and 20 degrees, such as between 14 degrees and 18 degrees. In optional embodiments, the angle 102 is about 16 degrees. In alternative embodiments, the angle 102 is about 4 degrees.

A height 112, width 114, and length 116 may be defined for the battery 100. Height 112 may be defined between an upper surface and a lower surface, such as along the vertical axis 204. Width 114 may be defined between a first side surface and a second side surface, such as along the lateral axis 202. Length 116 may be defined between a front surface and a rear surface, such as along the longitudinal axis 200. In some embodiments, a maximum length 116 of the battery 100 may be greater than a maximum width 114 of the battery 100. In some embodiments, a maximum length 116 of the battery 100 may be greater than a maximum height 112 of the battery 100. In some embodiments, a maximum width 114 of the battery 100 may be greater than a maximum height 112 of the battery 100.

In exemplary embodiments, the maximum width 114 of the battery 100 may be at least 90%, such as at least 95% such as at least 98%, such as at least 99%, such as 100% of the maximum width 77 of the housing 20, such as of the upper housing portion 84.

In some embodiments, the maximum length 116 of the battery 100 is between 200 millimeters (mm) and 300 mm, such as between 230 mm and 280 mm. In some embodiments, the maximum width 114 of the battery 100 is between 90 mm and 200 mm, such as between 95 mm and 185 mm, such as in some embodiments between 95 mm and 105 mm, such as in some embodiments 100 mm, such as in some embodiments between 180 mm and 185 mm, such as in some embodiments 181 mm. In optional embodiments, the width of the battery is variable, such as to define a maximum width 114 and a discrete minimum width. In some such embodiments, the minimum width is between 70 mm and 150 mm, such as between 80 mm and 125 mm, such as in some embodiments 100 mm In some embodiments, the maximum height 112 of the battery 100 is between 75 mm and 115 mm, such as between 90 mm and 110 mm. In some embodiments, the battery has a volume between 3200 cubic centimeters (cm) and 5800 cubic cm, such as between 3700 cm and 5300 cm, such as between 4100 cm and 4900 cm.

In exemplary embodiments, the maximum width 77 of the housing 20 is between 180 mm and 185 mm, such as between 181 mm and 183 mm, such as 182.5 mm.

In exemplary embodiments, the battery 100 is a lithium-ion battery. In exemplary embodiments, the battery 100 may provide at least 5 amp-hours, such as at least 5.5 amp-hours, such as at least 5.8 amp-hours, such as at least 6 amp-hours.

In exemplary embodiments, the battery 100 has a weight of between 8 pounds and 12 pounds, such as between 9 pounds and 11 pounds, such as between 10 pounds and 10.8 pounds.

In exemplary embodiments, a center of gravity of the chainsaw is located in the housing 20, such as in the interior 22. The center of gravity is calculated with the battery coupled to the housing 20 and all other necessary components of the chainsaw 10 included.

One suitable battery for use with chainsaws 10 in accordance with the present disclosure is the MX Fuel battery available from Milwaukee Electric Tool Company.

In exemplary embodiments, the battery 100 may be disposed above the primary handle 30 and, in some embodiments, the actuator 50 along the vertical axis 204. In exemplary embodiments, an uppermost portion of the secondary handle 32 may be disposed above the battery 100 along the vertical axis 204. For instance, the secondary handle 32 may wrap about the battery 100, such that the battery is mounted to the housing 20 at one end, extends above the battery (e.g., at the uppermost portion of the secondary handle 32), and mounts to another (e.g., bottom) portion of the housing 20 at the opposite end. In exemplary embodiments, the battery 100 may be disposed behind the brake 34 along the longitudinal axis 200. In additional or alternative embodiments, the battery 100 may be disposed above the brake 34 along the vertical axis 204. Further additionally or alternatively, the interior 22 and, in some embodiments, any features disposed therein, may be disposed below the battery 100 along the vertical axis 204.

Such configuration of the battery 100 may advantageously allow for use of a relatively large battery, which allows for improved performance, while also providing improved efficiency and ergonomics of the chainsaw 10.

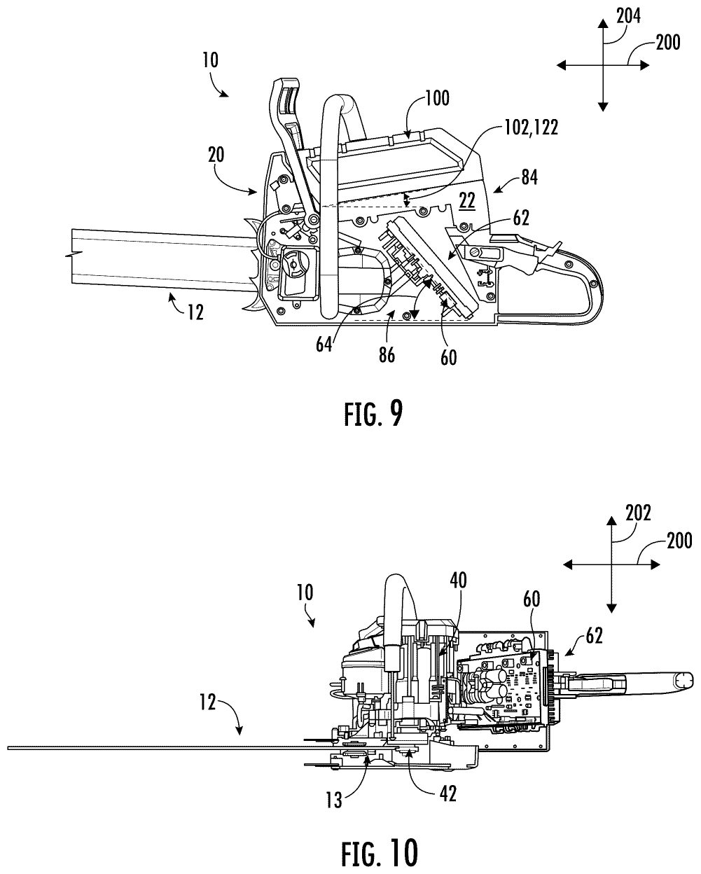

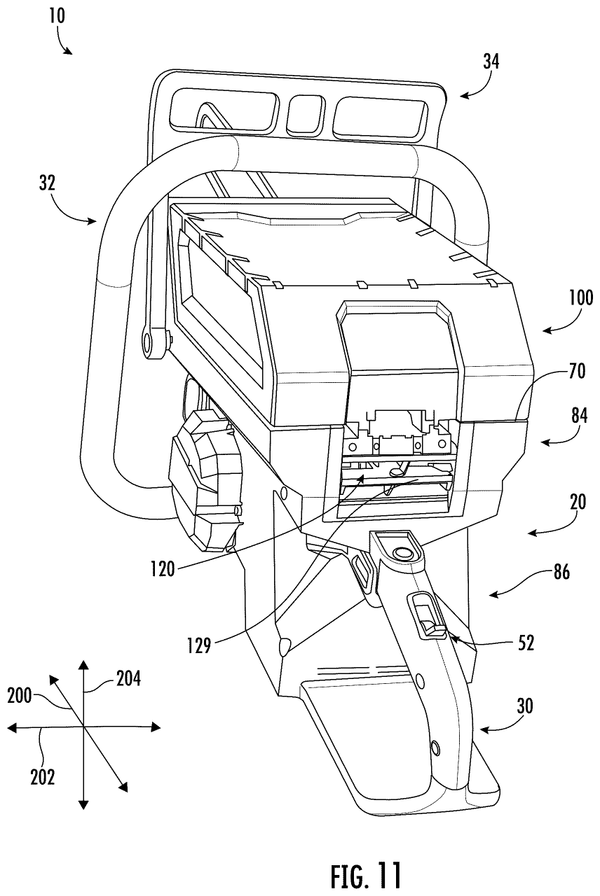

Referring now specifically to FIGS. 9 and 10, as discussed, in exemplary embodiments, a controller 60, such as one or more printed circuit boards 60, may be disposed within the housing 20, such as in the interior 22. In exemplary embodiments, at least 90% (as measured by volume) of the printed circuit board 60, such as at least 95% (as measured by volume) of the printed circuit board 60, may be disposed within the lower housing portion 86.

In some embodiments, a heat sink 62 may be disposed on one or more of the printed circuit boards 60. Heat sink 62 may extend along at least 90%, such as at least 95%, such as at least 98% of a width and a height of the corresponding printed circuit board 60.

In exemplary embodiments, one or more of the printed circuit boards 60may be disposed at an angle 64 relative to the longitudinal axis 200. The angle 64 may be a downward angle from the front surface 78 towards the rear surface 80 along the longitudinal axis 200. In exemplary embodiments, the angle 64 may be between 5 degrees and 65, between 10 degrees and 20 degrees, between 40 degrees and 60 degrees, such as between 45 degrees and 55 degrees, such as between 48 degrees and 52 degrees.

Such configuration of the printed circuit board 60 may advantageously allow for use of a relatively large printed circuit board 60, with for example, relatively large capacitors, within a relatively small space. This advantageously allows for improved performance, efficiency, and ergonomics of the chainsaw 10.

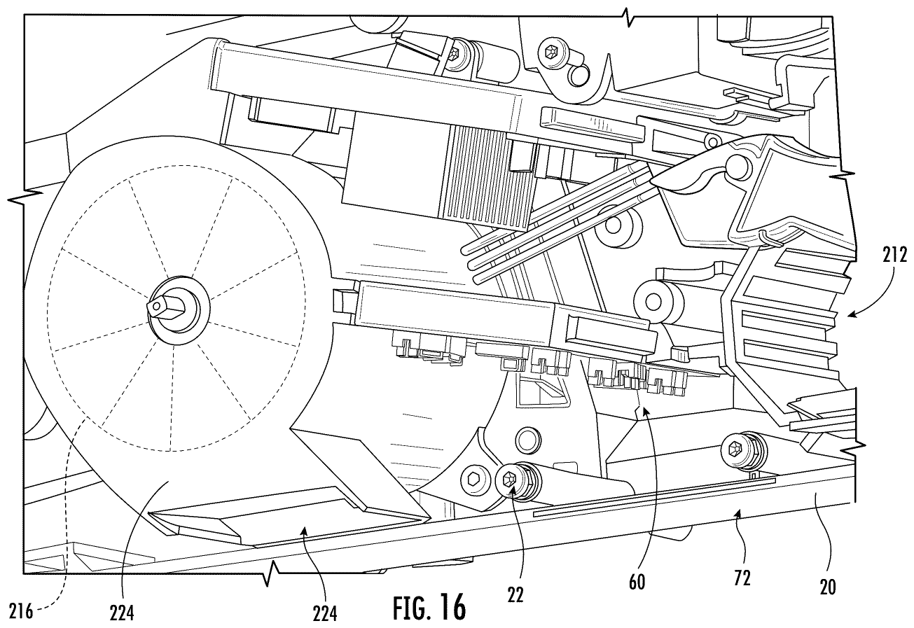

Turning now especially to FIGS. 15 through 17, an airflow path 210 may be defined through interior 22interior 22. In particular, airflow path 210 may be defined from an air intake 212 upstream from the interior 22 to an air exhaust 214 downstream from the interior 22. In some embodiments, one or both of air intake 212 and air exhaust 214 may be defined through housing 20. Moreover, one or more of the printed circuit boards 60 may be disposed along the airflow path 210.

As shown, air intake 212 may be defined at a rearward or back half of housing 20. For instance, air intake 212 may be generally defined as one or more openings provided at a rear end of housing 20. Additionally or alternative, air intake 212 may be defined along the longitudinal axis 200. Air flowing into interior 22 may, thus, travel along or parallel to the longitudinal axis 200. As shown, the primary handle 30 may extend rearward from the housing 20 (e.g., in a direction opposite guide bar 12). In some such embodiments, air intake 212 is disposed below the primary handle 30. As an example, air intake 212 may be defined (e.g., through a rearward facing wall or surface) between the primary handle 30 and the lower surface 72. In some such embodiments, the primary handle 30 and lower surface 72 form a hand loop within which a user's hand may be received. As shown, air intake 212 may be directed to the hand loop (e.g., to draw air therefrom).

Downstream from the interior 22, air exhaust 214 may be defined (e.g., through housing 20). In some embodiments, the air exhaust 214 being defined below the air intake 212. Thus, relative to the vertical axis 204, the air exhaust 214 may be defined at a lower location than air intake 212. Additionally or alternatively, air exhaust 214 may be spaced apart (e.g., forward) from air intake 212 relative to the longitudinal axis 200. In certain embodiments, air exhaust 214 is defined through the lower surface 72, such as at a location or region below the motive device 40. Optionally, air exhaust 214 may be defined directly beneath the motive device 40. As shown, air exhaust 214 may be directed downward (e.g., to direct air below housing 20).

As shown, a fan 216 (e.g., radial fan, tangential fan, or impeller) having one or more air blades may be mounted within the housing 20 (e.g., along the airflow path 210) to generate or motivate the airflow from the air intake 212 to the air exhaust 214. In some such embodiments, the fan 216 is mounted on or in mechanical communication the motive device 40. For instance, the fan 216 may be mounted to the motive device 40 opposite of the chain sprocket 42 (e.g., relative to the lateral axis 202). In turn, rotation of the chain or chain sprocket 42 may simultaneously rotate the fan 216 to generate the airflow through interior 22. In optional embodiments, a sub-enclosure 220 is disposed within the interior 22. Specifically, the sub-enclosure 220 may provide a solid body along which and through which a portion of the airflow path 210 is defined. In turn, sub-enclosure 220 may define an enclosure intake 222 and an enclosure exhaust 224. The enclosure intake 222 may be defined, for instance, along the longitudinal direction 200 or otherwise directed toward the air intake 212. Optionally, the enclosure intake 222 may be defined at a higher position relative to the vertical direction 204 than the air intake 212. Additionally or alternatively, the enclosure exhaust 224 may be defined, for instance along the vertical direction 204 or otherwise directed toward the air exhaust 214. Optionally, the enclosure exhaust 224 may be defined at a lower position relative to the vertical direction 204 than the enclosure intake 222 (e.g., directly above the air exhaust 214). As shown, the sub-enclosure 220 may house one or more components, such as the fan 216 or a portion of the motive device 40. A curved inner wall of the sub-enclosure 220 may be wrapped around at least a portion of the fan 216 or motive device 40. During use, air along the airflow path 210 may be gradually redirected from a substantially longitudinal flow to a substantially vertical flow (e.g., as air passes across the fan 216 or motive device 40).

Turning now to FIGS. 17 through 22, a lubrication system 302 may be provided (e.g., within the interior 22). Generally, the lubrication system 302 may dispense or deliver lubricant to the chain.

As shown, the lubrication system 302 includes a lubricant reservoir 330 configured to house a lubricant. The lubricant reservoir 330 is fluidly coupled to a pump 334 via a first hose 336, also referred to as a hose or a first hose. Downstream of the pump 334, a second hose 338 fluidly couples the pump 334 to an output 340 configured to dispense the lubricant adjacent to the chain so as to lubricate the chain. The pump 334 can draw lubricant from the reservoir 330 via the hose 336 and deliver lubricant through the second fluid conduit 338 to provide the lubricant at a location adjacent to the chain.

As shown, the pump 334 may be mounted within the interior 22 (e.g., proximal to the second side housing 20-FIG. 1). In some embodiments, pump 334 is driven by the motive device 40. For instance, pump 334 may be in mechanical communication with the same motive device 40 driving rotation of the chain 14 and/or fan 216. In certain embodiments, the pump 334 connects to the motor shaft 230 of the motive device 40 opposite of the fan 216 and sub-enclosure 220 (FIG. 15).

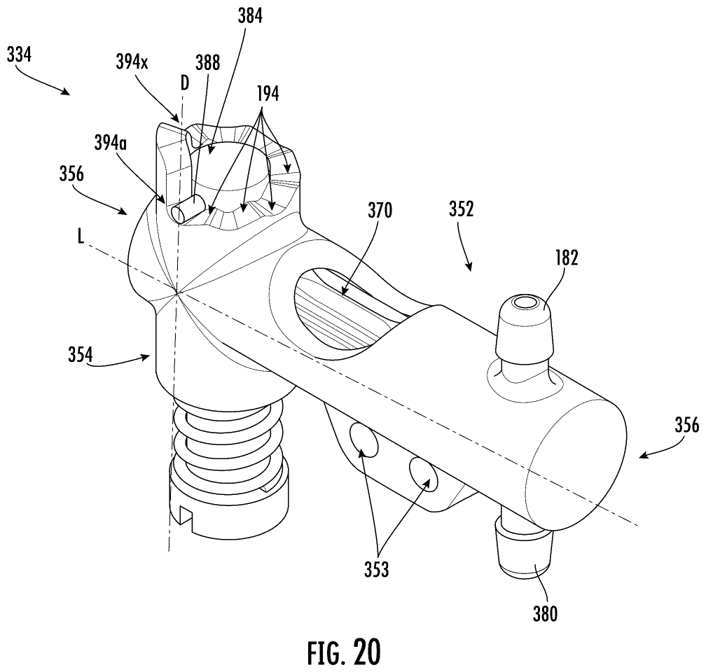

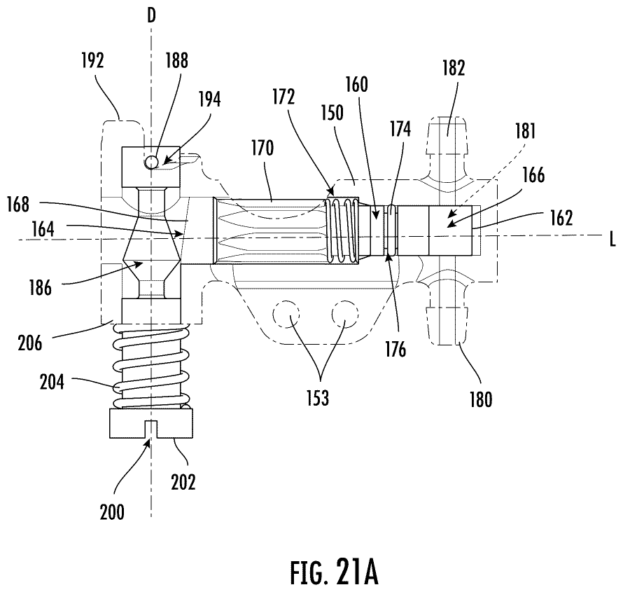

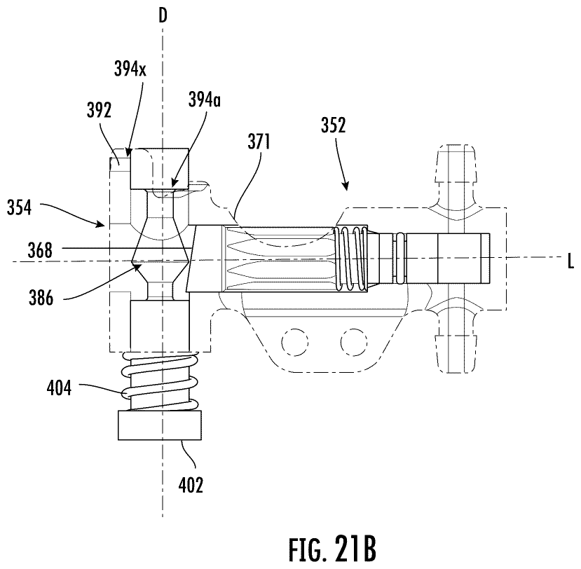

FIGS. 20 and 21A through 21B illustrate an embodiment of the pump 334 according to the present invention. The pump 334 includes a housing 350 having a first portion 352 extending along a longitudinal direction L and a second portion 354 extending in a second direction D. The second direction D may be generally perpendicular to the longitudinal direction L. The first portion 352 may extend from a first end 356 to a second end 358 along the longitudinal direction L. The second portion 354 may be disposed at the second end 358. In some aspects of the invention, the first portion 352 may have a generally cylindrical shape and the second portion 354 may have a generally cylindrical shape. One or more mounting holes 353 may be provided on the housing 350, e.g., extending from the generally cylindrical shape of the first portion 352.

The pump 334 includes a lubricant inlet 380 and a lubricant outlet 382 disposed generally near to the first end 356 and/or spaced apart from the second portion 354. The lubricant inlet 380 may be coupled with the fluid hose 336 or first hose to draw lubricant into the pump 334 from the reservoir 330, and the lubricant outlet 382 may be coupled with the fluid hose 338 or second hose to pump lubricant to the output 340. A chamber 381 is disposed between the lubricant inlet 380 and the lubricant outlet 382 for the lubricant to pass therethrough.

The pump 334 includes a piston 360 extending within the first portion 352 (as best seen in FIGS. 21A through 21B). The piston 360 has a first end 362 and a second end 364. At the first end 362, the piston includes a cut-out portion 366, e.g., a flat or rounded cut-out face extending inward along the longitudinal direction L from the first end 362. The cut-out portion 366 may be configured to be disposed between the lubricant inlet 380 and the lubricant outlet 382. At the second end, the piston 360 has an inclined surface 368 forming a cam surface.

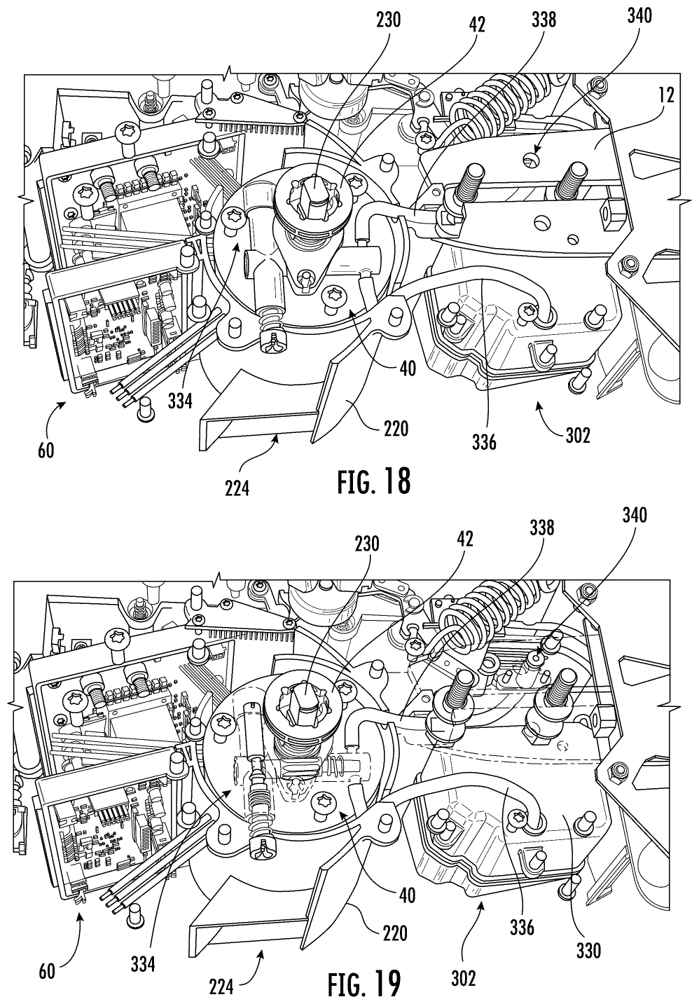

The piston 360 further includes a gear 370 configured to operably couple with the motor shaft 230 (FIG. 18) to cause reciprocal movement of the piston 360 along the longitudinal direction L. The gear 370 may extend about a circumference of the piston 360. A spring 372 may be positioned about the piston 360. For instance, the spring 372 may surround a portion of the piston 360. The spring 372 may be configured to bias the piston 360 toward the first end 356 or second end 358 of the housing 350. For instance, as illustrated in FIGS. 21A through 21B, the spring 372 may bias the piston 360 toward the second end 358.

The piston 360 may further include at least one seal 374. For instance, the piston 360 can include a channel 376 surrounding a circumference of the piston 360 disposed between the cut-out portion 366 and the second end 364 and the seal 374 may be disposed within the channel 376. The seal 374 can be an O-ring or any other suitable seal to prevent lubricant from spreading between the seal 374 and the second end 364.

In some embodiments, the pump 334 further includes a lubricant flow adjustment system. The lubricant flow adjustment system may be configured to adjust a flowrate of the pump 334 in a range from about 3 mL/min to about 20 mL/min, i.e., over a range spanning about 17 mL/min. Notably, the lubricant flow adjustment system of the present invention may provide a superior range of flowrates as compared to existing outdoor power tool lubricant flowrate adjusters.

The lubricant flow adjustment system includes an adjuster 384 operably coupled with the second portion 354 of the pump housing 350. The adjuster 384 can extend along the second direction D and extend within the second portion 354 of the housing 350. The adjuster 384 includes a pointed section 386 configured to be in operable contact with the inclined surface 368 of the piston 360. At least a portion of the adjuster 384 including a pin 388 is configured to extend outward from an opening 390 of the second portion 354 of the pump housing 350. At an opposite end of the adjuster 384 from the pin 388, the adjuster 384 may include a slot 400 on a bottom surface 402 of the adjuster 384. The slot 400 may be a minus slot (i.e., forming a straight line similar to a minus symbol ‘-’ across a lower surface of the adjuster 384), or any other suitable shape of a slot or keyed opening in the lower surface of the adjuster 384. An adjuster spring 404 may be positioned about the adjuster 384, e.g., between the bottom surface 402 and a lower surface 406 of the second portion 354 of the pump housing 350 to bias the adjuster 384 downward along the second direction D. The slot 400 may be operably coupled with a controlling mechanism (not shown) that may be configured to engage the slot 400 and rotate the adjuster 384 to a rotational position corresponding to a desired one of the detents 394 for an intended lubricant flow rate.

The lubricant flow adjustment system of the present invention including the adjuster 384 may have a retention force of about 2 in-lb torque or more, e.g., over 2 in-lb torque. Notably, increasing the retention force of the lubricant flow adjustment system of the present invention, as compared to existing outdoor power tool lubricant adjusters, enables more accurate adjustment of the flowrate by preventing the adjuster 384 from being inadvertently rotated (and thereby inadvertently changing the flowrate).

The second portion 354 has a top surface 392 thereof surrounding the opening 390. The top surface 392 includes a plurality of detents 394 of different height in the direction D. The pin 388 is configured to extend from the adjuster 384 in a direction generally perpendicular to the second direction D such that the pin 388 may rest on or be seated within one of the detents 394. As best seen in FIG. 2, the top surface 392 includes a plurality of detents 394, such as at least four detents, at least six detents, at least eight detents, or more, each extending at a different height along the direction D. In one particular embodiment, there may be seven detents 394. The detents 394 may increase in height from a first detent 394a to an ultimate detent 394x. The detents 394 may increase in height about a circumference of the second portion 354 of the housing 350. For instance, in some aspects the detents 394 may extend about a full 360-degree circumference of the second portion 354, or the detents 394 may extend about only a portion of a circumference of the second portion 354. For example, as illustrated in FIG. 20, the detents 394 may extend about an angle of 270 degrees of the circumference of the second portion 354.

A height of each respective one of the detents 394 may correspond to an amount of reciprocal movement of the piston 360 along the direction L by varying the point of contact between the pointed section 386 of the adjuster 384 and the inclined surface 368 of the piston 360. As the pin 388 is moved to a detent 394 of increased height, e.g., as illustrated in FIG. 31B, the pointed section 386 increases in height along the direction D, thereby reducing the reciprocal range of motion of the piston 360 due to the point of contact between the pointed section 386 and the inclined surface 368 of the piston 360. When the reciprocal range of motion of the piston 360 in the longitudinal direction L is decreased, less lubricant may pass through the pump 334 from the inlet 380 to the outlet 382 due to reduced range of motion of the cut-out portion 366 between the inlet 380 and the outlet 382. In contrast, when the pin 388 is disposed at the lowest detent 394a, e.g., as shown in FIGS. 20 and 21A, the pump 334 may operate at a maximum lubricant flow rate by enabling a maximum reciprocal range of motion of the piston 360.

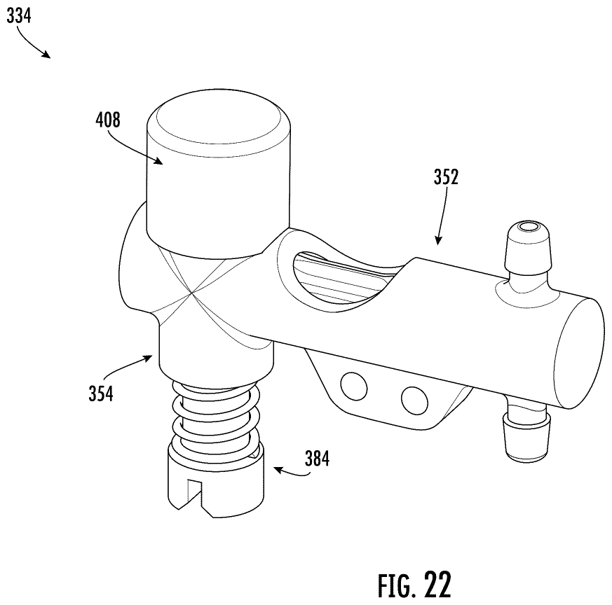

In some aspects of the invention, a cap 408 may be provided to cover the upper end of the adjuster 384 and the second portion 354 of the housing 350. For instance, the cap 408 may act as a grease cap to retain any grease or lubricant on the top surface 392 of the second portion 354 and/or the adjuster 384. In some aspects, the cap 408 may have a generally cylindrical shape as shown in FIG. 22. However, any suitably shaped cap 408 for retaining grease or lubricant and prevent the grease or lubricant from exiting the housing 350.

FIGS. 20 and 21A through 21B illustrate a pump 334 having a mid-gear style piston 360. In other words, the piston 360 has a gear 370 that is generally disposed at a mid-portion of the piston 360. As shown in FIGS. 20 and 21A through 21B, the housing 350, for instance, the first portion 352 of the housing 350, includes an opening 371 configured to expose the gear 370. In this arrangement, the gear 370 is disposed along the piston 360 at a position between the inclined surface 368 at the second end 364 and the cut-out portion 366 at the first end 362. However, the present invention contemplates any suitable style of piston gear assembly.

Further aspects of the disclosure are provided by one or more of the following embodiments:
A chainsaw, comprising: a guide bar comprising an outer track;
a chain movably coupled to the outer track; a motive device operable to move the chain relative to the guide bar; a housing defining an interior, wherein at least a portion of the guide bar and at least a portion of the motive device are disposed in the interior, the housing comprising an upper surface and a lower surface spaced apart along a vertical axis, a first side surface and a second side surface spaced apart along a lateral axis, and a front surface and a rear surface spaced apart along a longitudinal axis; and a battery interface disposed on the housing at the upper surface.

The chainsaw of any one or more embodiments disclosed herein, further comprising a brake mounted within the interior below the battery interface.

The chainsaw of any one or more embodiments disclosed herein, further comprising a battery, the battery removably coupled to the housing by the battery interface, the battery being disposed at a downward angle in a direction from the rear surface towards the front surface relative to the longitudinal axis.

The chainsaw of any one or more embodiments disclosed herein, wherein the angle is between 2 degrees and 25 degrees.

The chainsaw of any one or more embodiments disclosed herein, further comprising: a battery, the battery removably coupled to the housing by the battery interface; and a secondary handle mounted to the housing and extending over the battery.

The chainsaw of any one or more embodiments disclosed herein, wherein the housing defines an air intake upstream from the interior and an air exhaust downstream from the interior, the air exhaust being defined below the air intake.

The chainsaw of any one or more embodiments disclosed herein, further comprising a primary handle extending rearward from the housing in a direction opposite guide bar, wherein the air intake is defined through the housing between the primary handle and the lower surface, and wherein the air exhaust is defined through the lower surface.

The chainsaw of any one or more embodiments disclosed herein, further comprising a printed circuit board disposed within the interior in fluid communication between the air intake and the air exhaust.

The chainsaw of any one or more embodiments disclosed herein, wherein the printed circuit board is disposed at an angle between 10 degrees and 20 degrees relative to the longitudinal axis.

The chainsaw of any one or more embodiments disclosed herein, further comprising: a sub-enclosure disposed within the interior in fluid communication between the air intake and the air exhaust; and a fan mounted to the motive device within the sub-enclosure.

The chainsaw of any one or more embodiments disclosed herein, further comprising a lubrication system that provides lubricant to the chain, the lubrication system comprising: a reservoir housing the lubricant, a pump in mechanical communication with the motive device to be driven by the same, and an output configured to supply the lubricant to the guide bar and the chain.

A chainsaw, comprising: a guide bar comprising an outer track; a chain movably coupled to the outer track; a housing defining an interior, wherein at least a portion of the guide bar and at least a portion of the motive device are disposed in the interior, the housing comprising an upper surface and a lower surface spaced apart along a vertical axis, a first side surface and a second side surface spaced apart along a lateral axis, and a front surface and a rear surface spaced apart along a longitudinal axis, the housing defining an air intake upstream from the interior and an air exhaust downstream from the interior, the air exhaust being defined below the air intake; and a motive device mounted within the interior in fluid communication between the air intake and the air exhaust, the motive device being operable to move the chain relative to the guide bar.

The chainsaw of any one or more embodiments disclosed herein, further comprising a primary handle extending rearward from the housing in a direction opposite guide bar, wherein the air intake is defined through the housing between the primary handle and the lower surface, and wherein the air exhaust is defined through the lower surface.

The chainsaw of any one or more embodiments disclosed herein, further comprising a printed circuit board disposed within the interior in fluid communication between the air intake and the air exhaust.

The chainsaw of any one or more embodiments disclosed herein, wherein the printed circuit board is disposed at an angle between 10 degrees and 20 degrees relative to the longitudinal axis.

The chainsaw of any one or more embodiments disclosed herein, further comprising: a sub-enclosure disposed within the interior in fluid communication between the air intake and the air exhaust; and a fan mounted to the motive device within the sub-enclosure.

The chainsaw of any one or more embodiments disclosed herein, further comprising a lubrication system that provides lubricant to the chain, the lubrication system comprising: a reservoir housing the lubricant, a pump in mechanical communication with the motive device to be driven by the same, and an output configured to supply the lubricant to the guide bar and the chain.

A chainsaw, comprising: a guide bar comprising an outer track; a chain movably coupled to the outer track; a housing defining an interior, wherein at least a portion of the guide bar and at least a portion of the motive device are disposed in the interior, the housing comprising an upper surface and a lower surface spaced apart along a vertical axis, a first side surface and a second side surface spaced apart along a lateral axis, and a front surface and a rear surface spaced apart along a longitudinal axis; a motive device mounted within the interior and operable to move the chain relative to the guide bar; and a lubrication system that provides lubricant to the chain, the lubrication system comprising: a reservoir housing the lubricant, a pump in mechanical communication with the motive device to be driven by the same, and an output configured to supply the lubricant to the guide bar and the chain.

The chainsaw of any one or more embodiments disclosed herein, further comprising: a sub-enclosure disposed within the interior in fluid communication between the air intake and the air exhaust; and a fan mounted to the motive device within the sub-enclosure proximal to the first side surface, wherein the pump is disposed proximal to the second side surface.

The chainsaw of any one or more embodiments disclosed herein, wherein the motive device comprises a motor shaft, wherein the pump comprises a piston disposed within the housing, a bias spring configured to bias the piston in a first direction, and a gear configured to operably couple with the motor shaft to drive movement of the piston.

This written description uses examples to disclose the present application, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A chainsaw, comprising:
a guide bar comprising an outer track;
a chain movably coupled to the outer track;
a motive device operable to move the chain relative to the guide bar;
a housing defining an interior, wherein at least a portion of the guide bar and at least a portion of the motive device are disposed in the interior, the housing comprising an upper surface and a lower surface spaced apart along a vertical axis, a first side surface and a second side surface spaced apart along a lateral axis, and a front surface and a rear surface spaced apart along a longitudinal axis; and
a battery interface disposed on the housing at the upper surface.

2. The chainsaw of claim 1, further comprising a brake mounted within the interior below the battery interface.

3. The chainsaw of claim 1, further comprising a battery, the battery removably coupled to the housing by the battery interface, the battery being disposed at a downward angle in a direction from the rear surface towards the front surface relative to the longitudinal axis.

4. The chainsaw of claim 3, wherein the angle is between 2 degrees and 25 degrees.

5. The chainsaw of claim 1, further comprising:
a battery, the battery removably coupled to the housing by the battery interface; and
a secondary handle mounted to the housing and extending over the battery.

6. The chainsaw of claim 1, wherein the housing defines an air intake upstream from the interior and an air exhaust downstream from the interior, the air exhaust being defined below the air intake.

7. The chainsaw of claim 6, further comprising a primary handle extending rearward from the housing in a direction opposite guide bar, wherein the air intake is defined through the housing between the primary handle and the lower surface, and wherein the air exhaust is defined through the lower surface.

8. The chainsaw of claim 6, further comprising a printed circuit board disposed within the interior in fluid communication between the air intake and the air exhaust.

9. The chainsaw of claim 8, wherein the printed circuit board is disposed at an angle between 10 degrees and 20 degrees relative to the longitudinal axis.

10. The chainsaw of claim 6, further comprising:
a sub-enclosure disposed within the interior in fluid communication between the air intake and the air exhaust; and
a fan mounted to the motive device within the sub-enclosure.

11. The chainsaw of claim 1, further comprising a lubrication system that provides lubricant to the chain, the lubrication system comprising:
a reservoir housing the lubricant,
a pump in mechanical communication with the motive device to be driven by the same, and
an output configured to supply the lubricant to the guide bar and the chain.

12. A chainsaw, comprising:
a guide bar comprising an outer track;
a chain movably coupled to the outer track;
a housing defining an interior, wherein at least a portion of the guide bar is disposed in the interior, the housing comprising an upper surface and a lower surface spaced apart along a vertical axis, a first side surface and a second side surface spaced apart along a lateral axis, and a front surface and a rear surface spaced apart along a longitudinal axis, the housing defining an air intake upstream from the interior and an air exhaust downstream from the interior, the air exhaust being defined below the air intake; and
a motive device mounted within the interior in fluid communication between the air intake and the air exhaust, the motive device being operable to move the chain relative to the guide bar.

13. The chainsaw of claim 12, further comprising a primary handle extending rearward from the housing in a direction opposite guide bar, wherein the air intake is defined through the housing between the primary handle and the lower surface, and wherein the air exhaust is defined through the lower surface.

14. The chainsaw of claim 12, further comprising a printed circuit board disposed within the interior in fluid communication between the air intake and the air exhaust.

15. The chainsaw of claim 14, wherein the printed circuit board is disposed at an angle between 10 degrees and 20 degrees relative to the longitudinal axis.

16. The chainsaw of claim 12, further comprising:
a sub-enclosure disposed within the interior in fluid communication between the air intake and the air exhaust; and
a fan mounted to the motive device within the sub-enclosure.

17. The chainsaw of claim 12, further comprising a lubrication system that provides lubricant to the chain, the lubrication system comprising:
a reservoir housing the lubricant,
a pump in mechanical communication with the motive device to be driven by the same, and
an output configured to supply the lubricant to the guide bar and the chain.

18. A chainsaw, comprising:
a guide bar comprising an outer track;
a chain movably coupled to the outer track;
a housing defining an interior, wherein at least a portion of the guide bar is disposed in the interior, the housing comprising an upper surface and a lower surface spaced apart along a vertical axis, a first side surface and a second side surface spaced apart along a lateral axis, and a front surface and a rear surface spaced apart along a longitudinal axis;
a motive device mounted within the interior and operable to move the chain relative to the guide bar; and
a lubrication system that provides lubricant to the chain, the lubrication system comprising:
a reservoir housing the lubricant,
a pump in mechanical communication with the motive device to be driven by the same, and
an output configured to supply the lubricant to the guide bar and the chain.

19. The chainsaw of claim 18, further comprising:
a sub-enclosure disposed within the interior in fluid communication between an air intake and an air exhaust; and
a fan mounted to the motive device within the sub-enclosure proximal to the
first side surface,
wherein the pump is disposed proximal to the second side surface.

20. The chainsaw of claim 18, wherein the motive device comprises a motor shaft, wherein the pump comprises a piston disposed within the housing, a bias spring configured to bias the piston in a first direction, and
a gear configured to operably couple with the motor shaft to drive movement of the piston.
